(19) United States
(12) Patent Application Publication
(10) Pub. No.: US 2018/0207879 A1
(43) Pub. Date: Jul. 26, 2018

(54) METHOD FOR WELDING TWO DIFFERENT POLYOLEFIN PLASTICS

(71) Applicant: Henkel AG & Co. KGaA, Duesseldorf (DE)

(72) Inventors: Pablo Walter, Munchen (DE); Norman Friedrich, Munchen (DE); Lina Gonzalez, Munchen (DE); Hendrik Luetzen, Munchen (DE); Thomas Haertig, Munchen (DE); Dirk Kasper, Duesseldorf (DE)

(21) Appl. No.: 15/934,197

(22) Filed: Mar. 23, 2018

Related U.S. Application Data
(63) Continuation of application No. PCT/EP2016/074661, filed on Oct. 14, 2016.

(30) Foreign Application Priority Data
Oct. 16, 2015 (EP) 15190201.2

(51) Int. Cl. B29C 65/02; C09D 5/00; C09D 151/06

(52) U.S. Cl. CPC B29C 65/02; C09D 5/002; C09D 151/06; B29K 2623/0675; B29K 2623/0633; B29K 2623/0641; B29K 2623/065; B29K 2623/0625

(57) ABSTRACT

The invention relates to a method for welding two different polyolefin plastics using a primer, said primer containing at least one maleic anhydride graft polyolefin polymer. The invention also relates to correspondingly welded products.

The present invention relates to a method for welding two different polyolefin plastics materials using a primer, wherein the primer contains at least one maleic acid anhydride-grafted polyolefin polymer. The present invention also relates to products welded in this manner.

Various methods are known in the art for interconnecting two or more substrates made of plastics materials, such as polyethylene (PE), polyacrylates or polyamide (PA). This involves both mechanical connection options, such as latching or screwing, or bonding methods. Alternatively, plastics materials can also be welded together. Welding is a joining method for a non-detachable, material physical connection of plastics materials that are generally of the same type, such as PE to PE or PA to PA. Thermoplastics of the same type are those polymers which do not substantially differ in terms of molecular structure, melting point, melting viscosity and heat expansion coefficient, and can in principle be mixed together to an extent. Plastics materials of the same type are plastics materials that have an identical polymer-molecular structure or are identical plastics materials.

A wide range of methods are known for welding together two or more plastics materials of the same type. A wide range of welding methods can be used in this case, such as infrared welding, infrared/vibration welding or ultrasonic welding. These methods for welding plastics materials of the same type are based on the respective plastics materials being melted in the region of the welding zone, and the substances in this zone being integrally bonded to one another and frictionally interconnected.

These welding methods are effective insofar as plastics materials of the same type are intended to be interconnected. If, however, two plastics materials are intended to be welded together which are not of the same type, or which are incompatible with one another, for example plastics materials made of polyamide and poly(meth)acrylate, a permanent connection having high mechanical strength between the two substrates is not possible. However, even in the case of plastics materials which are similar, such as polyethylene with polypropylene, the welding often results in insufficient strength in the joint seam.

Until now, plastics materials which differ accordingly could be interconnected only by a mechanical connection or a bonding process. The drawbacks of a mechanical connection are complicated attachment, material strain at certain points and also the requirement for an additional mechanical connection means. In addition, integral bonding can rarely be achieved in the case of a mechanical connection. The drawback of a bonding process is, however, that the final strength of the connection is achieved only after a long period of time, which can be up to several weeks. In addition, bonding low-energy surfaces often requires complex pre-treatment of the joining parts. A bonded connection is also not infinitely stable on account of external atmospheric conditions. Providing a neat bonded connection is also often complicated and time-consuming. The connection by means of a method for welding plastics materials thus represents the neatest, quickest and simplest solution.

The aim of the present invention was therefore to find a simple method for welding two different polyolefin plastics materials, which method offers an improvement over the prior art in terms of the strength of the resulting connection. The connection between said plastics materials should thus be permanent and as stable as possible as a result of the weld.

Surprisingly, it was found that this aim was achieved by a method for welding two different polyolefin plastics materials using a primer, wherein the primer contains at least one maleic acid anhydride-grafted polyolefin polymer.

By using a primer containing at least one corresponding copolymer, particularly stable and age-resistant connections could be achieved between the polyolefin plastics materials when welding two different polyolefin plastics materials.

The joining parts for welding using a primer according to the invention are two different polyolefin plastics materials. Identical polyolefin plastics materials are understood to mean two polyolefins which do not differ in terms of either the polymer structure thereof or the type of filler. Suitable polyolefin plastics materials are in particular thermoplastic polyolefin plastics materials. A polyolefin plastics material is based on polyolefinic polymers, such as homopolymers and copolymers of alpha-olefins. The polyolefinic polymers can be selected from the group consisting of poly-alpha-olefin homopolymers based on ethylene, propylene and/or butylene, in particular ethylene homopolymers or propylene homopolymers, and poly-alpha-olefin copolymers based on ethene, propene, 1-butene, 1-hexene and 1-octene, in particular ethylene/alpha-olefin and propylene/alpha-olefin copolymers, preferably copolymers of ethene or propene having 1-butene, 1-hexene, 1-octene or a combination thereof. The polyolefin plastics materials are in particular selected from polyethylene plastics materials (in particular high-density/HD polyethylene, medium-density/MD polyethylene, low-density/LD polyethylene, ultra-high-molecular-weight/UHMW polyethylene and linear low-density/LLD-polyethylene) and polypropylene plastics materials. Particularly preferably, the first joining part is a polyethylene-plastics material, in particular a HD polyethylene, MD polyethylene, LD polyethylene, UHMW polyethylene or LLD polyethylene plastics material, preferably a HD polyethylene, MD polyethylene or LD polyethylene plastics material, and the second joining part is a polypropylene plastics material. Therefore, preferably, a polyethylene plastics material is welded to a polypropylene plastics material using the primer according to the invention. A polyethylene plastics material is particularly preferably ethylene-based; in particular, the polyethylene polymer has been produced from more than 50 wt. %, in particular more than 70 wt. %, preferably more than 90 wt. %, particularly preferably 100% ethylene.

Preferably, the polyolefin polymers, in particular polyethylene polymers and/or polypropylene polymers, have a weight-average molar mass (weight-average Mw) of greater than 10,000 g/mol, in particular greater than 20,000 g/mol, preferably greater than 50,000 g/mol. Preferably, the polyolefin polymers, in particular polyethylene polymers and/or polypropylene polymers, have a weight-average molar mass (weight-average Mw) of greater than 2,000,000 g/mol, in particular greater than 1,000,000 g/mol, preferably greater than 500,000 g/mol. Particularly preferred polyolefin polymers, in particular polyethylene polymers and/or polypropylene polymers, have a weight-average molar mass (weight-average Mw) of from 50,000 g/mol to 250,000 g/mol. Particularly preferred polyethylene polymers have a weight-average molar mass (weight-average Mw) of from 50,000 g/mol to 1,000,000 g/mol, in particular 200,000 g/mol to 500,000 g/mol. Other preferred polyethylene polymers (UHMW PE polymers) have a weight-average molar mass of greater than 2,000,000 g/mol, in particular of from 4,000,000 g/mol-6,000,000 g/mol.

The polyolefin plastics materials, in particular polyethylene plastics materials and/or polypropylene plastics materials, can also contain further components, e.g. fillers, such as glass fibers, pigments, dyes, rheological aids, demolding aids or stabilizers. The polyolefin plastics material, in particular the polyethylene plastics material and/or the polypropylene plastics material, particularly preferably consists of the specified polyolefin polymers, in particular the specified polyethylene polymers and/or polypropylene polymers, in an amount of greater than 80 wt. %, in particular greater than 90 wt. %, preferably greater than 98 wt. %, in each case based on the polymer proportion of the polyolefin plastics material (total polyolefin plastics material without fillers). The polyolefin plastics material preferably consists of the specified polyolefin polymers, in particular polyethylene and/or polypropylene, in an amount of greater than 50 wt. %, in particular greater than 70 wt. %, preferably greater than 90 wt. %, more preferably greater than 95 wt. %, particularly preferably greater than 98 wt. %, in each based on the total polyolefin plastics material (with fillers).

A further component essential to the invention is the use of at least one primer, preferably exactly one primer. The primer contains at least one maleic acid anhydride-grafted polyolefin polymer.

The primer constitutes a welding aid, which is preferably applied as a pre-treatment layer to at least one of the surfaces to be welded of the substrates, in the region of the joining zone. The primer is not to be understood as an adhesive, cleaning agent or similar; rather, the primer is a welding aid, as a result of which the joining parts are rendered compatible in the joining zone (or welding zone), resulting in integral bonding and a frictional connection between the substrates to be welded when joining occurs in the joining zone.

The experiments have shown that by using a corresponding primer, containing a polymer according to the invention, the plastics materials to be joined could be rendered compatible in the case of welding at the joint seam, thus making it possible to achieve a stable and permanent connection. Without using a corresponding primer, only lower strengths of the welded connection could be achieved. Preferably, the joined substrates have a tensile strength of greater than 12 MPa, in particular greater than 15 MPa. Tensile strength is determined by means of a tensile speed of 50 mm/s according to the experimental techniques described in the experiments.

The primer contains at least one maleic acid anhydride-grafted polyolefin polymer, which is selected in particular from maleic acid anhydride-grafted polyethylenes or maleic acid anhydride-grafted polypropylenes. The polyolefin can be grafted with a maleic acid anhydride or a maleic acid anhydride derivative, in particular maleic acid anhydride. One example of a maleic acid anhydride derivative is 1,2,3,6-tetrahydrophthalic anhydride, which includes the relevant 5-member anhydride group. The primer preferably contains a mixture of maleic acid anhydride-grafted polyolefins. The mixture can contain two or more, preferably two, different maleic acid anhydride-grafted polyolefin polymers. A person skilled in the art understands different maleic acid anhydride-grafted polyolefin polymers to be two polymers that differ in terms of molecular structure, e.g. with respect to molecular weight or monomer composition. The primer preferably contains a mixture of at least one maleic acid anhydride-grafted polyethylene and at least one maleic acid anhydride-grafted polypropylene. The ratio of the different maleic acid anhydride-grafted polyolefin polymers, in particular the ratio of maleic acid anhydride-grafted polyethylene to maleic acid anhydride-grafted polypropylene is 0.2:1 to 20:1, in particular 0.5:1 to 10:1, preferably 1:1 to 5:1, particularly preferably 1.5:1 to 3:1.

The polymers may be synthesized in a known manner. The polyolefin polymers could also contain small amounts of non-alpha-olefin monomers, such as styrene or acrylates. The polyolefin polymers are preferably not block copolymers. In particular, the polyolefins contain less than 10 wt. %, preferably less than 2 wt. %, more preferably less than 1 wt. %, particularly preferably no monomers selected from styrene and acrylates, in particular no alpha-olefin monomers. The polymers could also be further grafted in a polymer-analogous reaction. Particularly preferred reaction partners for grafting are alcohols, thiols, amines, isocyanates, anhydrides, carboxylic acids, in particular alcohols, preferably alcohols having 1 to 6 carbon atoms, such as methanol and isobutanol. For the grafting, the maleic acid anhydride monomers or maleic acid anhydride units in the polymer can react with the reaction partner, in particular using alcohols or using amines. In particular, the polymers can also be further grafted with maleic acid anhydride in order to increase the maleic acid anhydride content. In particular in the case of mixtures of polyolefins, in particular of polyethylene and polypropylene, said polyolefins can be further grafted, in particular with amines, preferably diamines, in order to be interconnected. Preferably, only some of the maleic acid anhydride groups react, in particular less than 90 mol %, preferably less than 70 mol % of the maleic acid anhydride groups. Preferably, some of the maleic acid anhydride groups are reacted with amines, in particular aliphatic amines, preferably aliphatic diamines, such as hexamethylenediamine. Preferably 5-100 mol %, in particular 10-80 mol %, preferably 20-70 mol % of the maleic acid anhydride groups of the polymer according to the invention, in particular of the maleic acid anhydride groups of a mixture of maleic acid anhydride-grafted polyolefin polymers, are reacted with amines.

In another preferred embodiment, the maleic acid anhydride groups are not reacted and continue to be present as an anhydride. In the preferred embodiment, the maleic acid anhydride groups can also be hydrolyzed in part. A complete reaction of the maleic acid anhydride groups can lead to a reduction in the strength of the resulting welded connection.

Polymers, in particular mixtures of polyolefin polymers, containing a maleic acid anhydride content of no less than 0.001 wt. %, in particular no less than 0.01 wt. %, preferably no less than 0.02 wt. %, particularly preferably no less than 0.05 wt. % based on the polyolefin polymer or the mixtures thereof, are particularly advantageous. Advantageously, the polymers or mixtures contain a maleic acid anhydride content of from 0.01-15 wt. %, in particular 0.02-10 wt. %, preferably 0.5-5 wt. % based on the polyolefin polymer or the mixtures thereof. In another preferred embodiment, the polymers or mixtures contain a maleic acid anhydride content of from 2-15 wt. %, in particular 5-10 wt. % based on the polyolefin polymer or the mixtures thereof. Polyolefin polymers having a corresponding maleic acid anhydride content have particularly good strengths of the welded connection.

Advantageously, the maleic acid anhydride-grafted polyolefin polymers have a weight-average molecular weight Mw of no less than 5,000 g/mol, in particular no less than 50,000 g/mol, preferably no less than 100,000 g/mol. The copolymers preferably have a weight-average molecular weight Mw in the range of from 5,000-2,000,000 g/mol, in particular 50,000-1,000,000 g/mol, preferably 100,000-500,000 g/mol. Polymers having a corresponding weight-average molecular weight have a positive effect on the brittleness and strength of the obtained connection. The weight-average molecular weight can be determined by means of GPC against a polystyrene standard.

Mixtures of different maleic acid anhydride-grafted polyolefins are particularly preferred, in particular a mixture of maleic acid anhydride-grafted polyethylene and polypropylene. Particularly good results were observed in terms of tensile strength when using corresponding mixtures in the primer. The primer preferably consists of a corresponding mixture in an amount of at least 50 wt. %, in particular 70 wt. %, preferably 90 wt. %, more preferably 95 wt. %, particularly preferably 99 wt. %.

In addition to the polymer according to the invention, the primer can preferably contain at least one further polymer. The at least one further polymer or copolymer is preferably a polyolefin polymer that is compatible with at least one of the two plastics materials to be welded and with the primer. Particularly preferably, the primer contains at least one polyolefin polymer without maleic acid anhydride groups, in particular a polyethylene and/or polypropylene without maleic acid anhydride groups. The use of an additional polymer alongside the maleic acid anhydride-grafted polyolefin polymers in the primer according to the invention can lead to further improvements in strength.

As a compatible further polymer, a polymer is preferably used which has a weighted squared distance of the Hansen parameters (Ra)² of less than 22 MPa, in particular less than 17 MPa, preferably less than 15 MPa, particularly preferably less than 12 MPa with respect to one, in particular with respect to the two plastics materials to be joined, and in particular also with respect to the above-mentioned first polymer according to the invention.

The weighted squared distance of the Hansen parameters (Ra)² is determined according to the following formula:

(Rₐ)²=4(Δδ_{D})²+(Δδ_{P})²+(Δδ_{H})²

In this formula, δ_{D} is the Hansen parameter for the dispersion forces, δ_{P} is the Hansen parameter for polarity and δ_{H} is the Hansen Parameter for hydrogen bridge bonds. Δδ_{D}, Δδ_{P} and Δδ_{H} each represent the differences of these Hansen parameters from the plastics materials or polymers to be compared, e.g. Δδ_{D}=(δ_{D1}−δ_{D2}) of Polymers 1 and 2. The values of the individual Hansen parameters δ_{D}, δ_{P} and δ_{H} for the respective plastics materials or polymers are determined according to the book “Hansen Solubility Parameters: A User's Handbook” by Charles M. Hansen (second edition; Taylor & Francis Group; 2007; ISBN-10 0-8493-7248-8). Numerous values for individual polymers can already be retrieved using this source. According to the method described in this book, the Hansen parameters are preferably retrieved from the supplied database using the HSPIP program (4th edition 4.1.07) or, if they are not there, using the “DIY” functionality contained in the program, preferably using the supplied neural network as described in the help section. The HSPIP program can be obtained from Steven Abbott TCNF Ltd.

The content of the further polymer, in particular the polyolefin polymer without maleic acid anhydride groups, in the primer is preferably 1-40 wt. %, in particular 5-30 wt. %, particularly preferably 10-20 wt. %, in each case based on the total weight of the primer. The content of the further polymer, in particular the polyolefin polymer without maleic acid anhydride groups, in the polymer content of the primer is preferably 5-70 wt. %, in particular 20-60 wt. %, particularly preferably 30-50 wt. %, in each case based on the total polymer proportion of the primer (primer without solvents and without fillers).

In a particularly preferred embodiment, the primer does not contain any further polyethylene polymers and/or polypropylene polymers without maleic acid anhydride groups, in particular no polyolefin polymers without maleic acid anhydride groups.

In addition to the polyolefin polymer according to the invention and the further polymer, the primer can also contain a solvent, in particular an organic solvent. The primer preferably has a solvent content of from 10-95 wt. %, in particular 50-90 wt. %, particularly preferably 70-85 wt. %, in each case based on the total weight of the primer.

Suitable solvents are all common solvents, such as water, alcohols such as ethanol, alkanes such as isooctane, ketones such as methyl isobutyl ketone (MIBK) or cyclohexanone (CH), ethers such as diethyl ether or tetrahydrofuran (THF), esters such as ethyl acetate, or carbonates such as dimethyl carbonate or dipropyl carbonate, toluene, xylene or mixtures thereof.

If organic solvents are used, the total polymer content of the primer is preferably 1-90 wt. %, in particular 2-50 wt. %, particularly preferably 5-15 wt. %, in each case based on the total weight of the primer. The total polymer content corresponds to the content of all the polymers used in the primer, in particular the polyolefin polymers according to the invention and the above-described further polymers.

In another preferred embodiment, the primer is in the form of an aqueous dispersion or emulsion. In this case, the polyolefin polymer according to the invention and, if present, the further polymers are emulsified or dispersed in water. In this case, the total polymer content of the primer is preferably 5-90 wt. %, in particular 20-70 wt. %, particularly preferably 30-55 wt. %, in each case based on the total weight of the primer. For the aqueous dispersion/emulsion, it is advantageous for the polymer component to substantially consist only of the polyolefin polymer according to the invention or the mixture thereof and, if present, the above-mentioned further polymer, in particular to consist only of the polymer according to the invention or the mixture thereof. According to the invention, the term “substantially” is understood to mean when the polymer component consists of the polyolefin polymer according to the invention and, if present, the above-mentioned further polymer in an amount of more than 95 wt. %, preferably more than 97 wt. %, very particularly preferably more than 99 wt. %, in particular consists only of the polyolefin polymer according to the invention or the mixture thereof.

In a particularly preferred embodiment, the primer is substantially free of solvents.

In addition to the polyolefin polymer according to the invention, in particular a mixture of maleic acid anhydride-grafted polyethylene and polypropylene, the above-mentioned further polymers and a solvent, the primer can contain further components such as fillers, (fluorescent) dyes and pigments, defoaming agents, rheological aids, wetting aids, stabilizers or plasticizers. The further components, in particular for the case in which the primer is substantially free of solvents, can be contained in amounts of up to 70 wt. %, in particular up to 50 wt. %, preferably up to 30 wt. %. With the exception of dyes and pigments, the primer is, however, substantially free of further components, in particular substantially free of any other components. According to the invention, the term “substantially free from” means when the primer contains less than 5 wt. %, preferably less than 1 wt. %, very particularly preferably less than 0.1 wt. % of the respective substances, in particular does not contain the respective substances.

In the method according to the invention for welding two different polyolefin plastics materials, a primer is used, wherein the primer contains at least one maleic acid anhydride-grafted polyolefin polymer.

In this method, the primer is used as an aid for welding the two different polyolefin plastics materials by melting in each case. As a result of the primer used, which contains at least one polyolefin polymer according to the invention, compatibility arises between the two joining parts, as a result of which stable and permanent integral bonding can be produced between the two plastics materials.

The primer can be applied to the surface of one or both joining parts using a wide range of methods. For example, the application can take place by means of a dosing device, a needle and dosing robot, injection molding, extrusion, film application, application as a hot melt, spraying, spreading or dipping. In the process, the primer can either be applied to only one surface or to both surfaces of the substrates to be welded. The primer is preferably applied to only one surface. In the case of welding by means of a film, the film is inserted between the substrates.

If the primer contains solvent or is used as an emulsion/dispersion, the primer is preferably dried after application to one or both surfaces until the solvent has evaporated such that a non-adhesive, dimensionally stable primer layer remains. In particular, the primer can be welded after only a few seconds and remains weldable for up to several weeks. Preferably, the primer is dried for at least an hour, preferably for at least 12 hours after application.

The advantage of the present primer is that it can be welded after only a few seconds following application, and also retains the welding capacity for several weeks. This applies all the more when the primer is used without solvents, in particular as a hot melt.

Preferably, the application to one or both surfaces of the substrates to be welded is such that the primer has a layer thickness of from 1 μm to 5,000 μm, in particular 100-3,000 μm, preferably 500-1000 μm. If a solvent was contained in the primer, the layer thickness refers to the primer dried by the solvent.

Following application to one or both surfaces of the substrates to be welded and optionally following drying of the primer, the substrates to be welded can be interconnected by means of a conventional welding method. Plastics materials are generally welded by local plasticizing of the joining parts in the joining plane and by pressurized joining. The process parameters are selected such that a pronounced squeeze flow of the melt leads to an optimum connection of the joining parts in the joining plane. The heating can take place by means of convection, heating by contact, radiation or friction. The varying energy input for the plasticizing can take place in a number of ways, and has led to different methods for welding plastics materials. Suitable welding methods are, for example:
Hot gas welding [HG]

Convective heating by means of a hot gas flow, generally air, two-stage process
Hot plate welding [HE]

Heating by contact, two-stage process
Ultrasonic welding [US]

Heating by friction, a transverse wave in the ultrasonic range induces heating in the boundary layer, single-stage process
High-frequency welding [HF]

Heating by internal friction, polar molecules are oriented according to a corresponding high-frequency magnetic field, single-stage, process, only used for polar plastics materials and films
Vibration welding [VIB] (linear; orbital; spin; angle)

Heating by friction, single-stage process
Laser welding [LW] (contour, simultaneous, quasi-simultaneous, mask)

Heating by radiation, coherent radiation, laser transmission welding, generally single-stage process (two-stage is possible)
Infrared welding [IR]

Heating by radiation, incoherent radiation, two-stage process

The above-described welding methods can optionally also be combined, for example infrared welding with vibration welding. The polypropylene plastics material is particularly preferably welded to the polyethylene plastics material using a welding method selected from hot plate welding, vibration welding, thermal contact or impulse welding, warm or hot gas welding, microwave or induction welding. Laser butt or penetration welding, infrared welding, ultrasonic welding and combinations thereof, in particular selected from infrared welding, vibration welding, hot plate welding, ultrasonic welding and combinations thereof.

A method containing the following steps is particularly preferred for integrally joining the two plastics materials using the primer:

Providing the first plastics material having a first joining zone,

Providing the second plastics material having a second joining zone,

Pre-heating the first joining zone,

Applying the primer to the pre-heated first joining zone, in particular in the case of solvent-free primers,

Bringing the first joining zone provided with the primer into contact with the second joining zone,

Integrally bonding the first joining zone and the second joining zone, in particular by using conventional methods for welding plastics materials, such as infrared welding, hot plate welding, hot gas welding, vibration welding or ultrasonic welding.

The teaching of DIN 1910-3:1977-09 can generally be applied to welding plastics materials. This can therefore be understood as integrally bonding thermoplastics with the aid of heat and/or pressure. The heating can take place for example on the basis of heating by contact (welding by solid elements), convection heating (welding by warm gas), radiation heating (welding by radiation) and heating by friction (welding by movement), and the welding can take place by electric current.

In an advantageous development, a primer is used which is selected and tailored to the method such that the application to a heated and/or hot joining zone at a temperature that is lower than the decomposition temperature of the polymers in the primer has no impact on the internal chemical cross-linking of the primer.

It is advantageous for the first joining zone to pre-heat the first plastics material. Aids and techniques that are known to a person skilled in the art and suitable for the intended use can be used for the pre-heating. The use of warm gas or plasma is particularly useful for pre-heating. It is also conceivable for pre-heating to take place by means of radiation, in particular infrared radiation or laser radiation. A hot plate or a heated tool can also be used to pre-heat the first joining zone. Finally, pre-heating in a furnace or a heated chamber is also conceivable. It is conceivable to pre-heat the whole plastics material and thus also said joining zone. Alternatively or in addition, pre-heating only in the joining zone itself is also possible.

In an advantageous development, the distance, during pre-heating, between the heating device and the plastics material, in particular the first joining zone to be pre-heated, in particular the heat-emitting region of the heating device or the heat-releasing region of the heating device or the active surface of the heating device to be pre-heated or the region of the heating device that is opposite the first joining zone is in a range of from 0.5 mm to 100 mm, preferably in the range of from 1 mm to 60 mm. Alternatively, it is also conceivable for heating to take place by and/or in the case of in particular the first joining zone being brought into contact with the hot plate of the heating device.

A further advantage is selecting the plastics material for the first joining part and adjusting the method parameters to the first plastics material such that the first joining zone is melted during pre-heating, and a melt layer is produced in the first joining zone during pre-heating. The thickness of the melt layer in a preferred embodiment is preferably in the range of from 0.05 mm to 6 mm, particularly preferably in the range of from 0.1 mm to 5 mm. A melt layer of this kind can lead to improved adhesion and/or diffusion and/or interaction of the molecules and, in conjunction with a certain flow, can lead to an improved connection layer. If the boundary layer of the first plastics material is in the molten state, there can be interactions with the primer which go as far as chemical bonds. The melt layer can in particular depend on the component geometry and the relevant component design. Preferably, the method parameters are adjusted and/or selected such that the components are not deformed. Preferably, differences in temperature between the joining zone and the primer to be applied can be compensated for by taking suitable measures and/or method steps. In this case, it is in particular conceivable to pre-heat the primer in order to reduce the difference in temperature between the preferably thermoplastic primer and the first joining zone. This can counteract the rapid cooling of the first joining zone between the method steps, for example.

Optionally, pre-treatment of the first joining zone takes places before the step of pre-heating the first joining zone. Alternatively or in addition, the second joining zone can also be pre-treated. Cleaning by means of a solvent or a for example alkaline plastics cleaner are both conceivable as a possible pre-treatment. Mechanical pre-treatment can also be used, in particular by means of scraping, sanding, brushing or radiation. Conceivable chemical pre-treatments are in particular acid cleaning or the use of reactive gases. Furthermore, the use of a thermal, chemical and/or physical pre-treatment could be expedient, in particular by means of a gas flame or plasma arc. Alternatively or in addition, electrical pre-treatment can take place by means of corona discharge, in which the first joining zone and/or the second joining zone is subjected to electrical corona discharge, resulting in polar molecules on the corresponding surface. A further possibility is plasma treatment, preferably using a plasma nozzle for pre-treating the joining zone, in particular by activating and/or cleaning the corresponding surface. Coating by means of plasma can also be expedient. A further possibility is flame treatment of the joining zone in order to increase the surface tension in the case of suitable plastics materials. A further form of pre-treatment is radiation by means of UV rays, electron rays, radioactive rays or by means of lasers. Finally, the pre-treatment can be in the form of a coating, in particular a coat of paint or an adhesion promoter. Pre-treating the first plastics material or the joining zones of the first plastics material such that there is a longer timer interval before the pre-heating is also conceivable. For example, it is conceivable for the pre-treatment to be carried out as part of the manufacturing process of the first plastics material in order for the pre-treated plastics material to be further processed in the method according to the invention.

It is conceivable for the primer to be applied in a number of ways. For example, and in particular in industry, application by means of an automatic application aid, in particular by means of a dosing robot, is conceivable. Said robot may be provided with a needle and/or height sensor in this case, in order to be able to carry out complex dosing. The primer can also be applied by means of injection molding, in which the primer is plasticized in an injection molding machine and pressure-injected into the mold containing the first plastics material having the first joining zone. Alternatively, film-application is also conceivable, wherein, in a first step, a film is produced from the primer by means of film blowing or cast film extrusion. Subsequently, the film can for example be adapted into any desired shape by means of a cutting or stamping process and, in a further step, can be applied to the first joining zone following the above-mentioned pre-heating. In this case, the use of films/plates having a thickness in the range of from 1 μm-5,000 μm is expedient. Further conceivable embodiments are extrusion welding, in which the primer is in the form of a welding wire, or is melted in an extruder and can be applied to the first joining zone as a melt. The primer can also be provided in the form of a welding wire in order to make application by means of hot air welding possible. Applying the primer by means of a spraying process is a further possibility. Pre-treatment and/or pre-heating and/or local variations in the temperature of the injection mold are also possible in the case of application by injection molding. Of course, other types of application that are known to a person skilled in the art and are suitable for the specific implementation are also conceivable.

A further advantage is the further heating or heating of the first joining zone during application of the primer, in particular in order to avoid the temperature of the first joining zone dropping between pre-heating and application of the primer. This can take place my means of the above-described pre-heating method step, which is continued during application for the sake of convenience. Alternatively or in addition, additional heating is possible in particular by means of a further method step. For example, it can be expedient for simultaneous heating of the first joining zone to be carried out, for example by means of simultaneous radiation of the first joining zone, forced convection or heating by contact during application, in order to avoid the temperature of the first joining zone dropping after pre-heating.

In an advantageous development, the primer is applied such that a connection layer having a thickness in the range of from 1 μm to 5 mm, preferably in the range of from 10 μm to 3 mm, is arranged on the first joining zone. The thickness of the connection layer is in this case to be understood as the material thickness of the connection layer on the first joining zone.

A further advantage is applying the primer to the first joining zone by means of a dosing device, by way of a relative movement between the first joining zone and the dosing device, the first joining zone, to which the primer is applied, being pre-heated by means of a heating device before the primer is applied by way of a relative movement between the first joining zone and the heating device, and the primer being applied by means of the dosing device when the first joining zone is pre-heated.

In this regard, it has proven advantageous for the heating device to be guided past the first joining zone at a speed in the range of from 10 mm/min to 100 min, preferably in the range of from 10 mm/min to 30 m/min during pre-heating.

It can also be advantageous for the dosing device to trail the heating device preferably at a defined and constant spacing. It is particularly advantageous for the method to be carried out such that the primer is applied to the first joining zone by means of a dosing device, by way of a relative movement of the dosing device and the first joining zone in the range of from 10 mm/min to 100 m/min, preferably in the range of from 10 mm/min to 30 m/min, said joining zone, to which the primer is applied, being pre-heated by means of a heating device before the primer is applied by way of a relative movement of the heating device and the first joining zone, and the dosing device or a nozzle of the dosing device for applying the primer simultaneously trailing the heating device at a time interval in the range of from 0.1-10 s.

In this regard, it has proven advantageous to use a coating unit consisting of a dosing device and a heating device. A coating unit is in this case to be understood in particular as a unit which provides a rigid connection between the heating device and the dosing device such that the dosing device trails the heating device preferably at a defined and constant spacing during the relative movement, in order to ensure that the first joining zone is pre-heated immediately before the primer is applied. Of course, in this regard, adjusting the spacing or, in the case of convective pre-heating, adjusting the volumetric flow rate or the nozzle diameter of the medium, in particular using suitable mechanical or electromechanical or also pneumatically operated adjusters, is also conceivable.

Alternatively, the coating unit can also be understood to mean a heating device and a dosing device as two completely independent or separate assemblies which, however, perform the same or substantially the same relative movement with respect to the plastics material in order to ensure that the location intended for primer application is pre-heated immediately before the primer is applied.

In an advantageous development, although the heating device and the dosing device perform substantially the same primary relative movement or have substantially the same basic orientation with respect to the plastics material, at least one of the two specified devices undergoes, in addition to said primary relative movement, an additional relative movement with respect to the plastics material. For example, the heating device and/or the dosing device can, in addition to the primary relative movement in which for example the primer can also be applied, perform one or more secondary relative movements. For example, in particular the heating device and/or the dosing device can perform or undergo a secondary relative movement that revolves around the primary relative movement or is meander-like.

In this case, the plastics material on the one hand, or the heating device and the dosing device, or the two devices together as the coating unit, on the other hand, can be moved. In the process, it is possible for the heating device and the dosing device, or the two devices together as the coating unit, on the one hand, or the plastics material on the other hand to stand still, or in each case to be moved by means of the moving part thereof in different directions.

In an advantageous development, there is a primary relative movement at a speed in the range of from 10 mm/min to 100 m/min, preferably in the range of from 10 mm/min to 30 m/min, and therefore, in particular also on account of the heating device being suitably designed, the plastics material spends as little time as possible inside the heating surface of the heating device, in particular in a range of from 1-60 s. This can include the region or space around the heating device which has an impact on the temperature by way of a temperature increase, thus pre-heating the first joining zone of the first plastics material. Heating that is too high and damage to or deterioration of the plastics material can thus be avoided, for example.

It can also be advantageous, in particular for attaching the dosing device and/or the heating device to/into existing production lines, to provide the heating device with a bus interface, in particular a PROFIBUS or a real-time Ethernet interface.

After applying said primer, the second joining zone is brought into contact with the primer layer. In this regard, it can be expedient to fasten the two plastics materials to one another, in particular by means of clamping devices or other fixing aids which are known to a person skilled in the art.

Of course, the second joining zone can optionally be pre-treated before the step of bringing the second joining zone into contact with the primer layer. In this case, in particular all the techniques described above are conceivable for pre-treatment. Pre-treating the second plastics material or the joining zones of the second plastics material such that there is a longer time interval before the contacting is also conceivable. For example, it is conceivable for the pre-treatment to be carried out as part of the manufacturing process of the second plastics material in order for a pre-treated plastics material to be further processed in the method according to the invention. Pre-treating the second plastics material can also include applying the primer to the second joining zone. In this case, it is preferably conceivable for the second joining zone to be pre-heated before the primer is applied. The above-mentioned embodiments are also preferred at this stage.

A joining process follows on from the above-described contacting of the second joining zone and the primer, in which process the treated and/or coated joining parts are plasticized using a heat supply and preferably integrally bonded to one another under the effect of pressure. For said integral bonding between the second joining zone and the primer, it is conceivable to use a heat supply by means of thermal conduction, for example by means of hot plate welding and/or thermal contact welding and/or thermal impulse welding; by friction, in particular ultrasonic, friction/vibration or high-frequency welding; microwave or induction welding; by convection, for example warm gas or hot gas welding; by means of radiation, for example infrared, laser butt or laser penetration welding, or also by combining two or more of these techniques.

A further object of this invention is items or products produced in accordance with the method according to the invention.

The use of a primer according to the invention for welding two different polyolefin plastics materials is also an aim of the invention.

### EMBODIMENTS

Materials used and abbreviations:
PP=polypropylene
PE=polyethylene
MAH=maleic acid anhydride
Primer 1=PE-(MD)-(MAH) with MFR (190° C.; 21.6 Kg)=12-22 and PP-MAH with
MFR (230° C.; 2.16 Kg)=7-12 in the ratio of 1:1 w/w compounded
Primer 2=PE-(MD)-(MAH) with MFR (190° C.; 21.6 Kg)=12-22 and PP-MAH with
MFR (230° C.; 2.16 Kg)=7-12 in the ratio of 2:1 w/w compounded
Primer 3=PE-(MD)-(MAH) with MFR (190° C.; 21.6 Kg)=12-22 and PP-MAH with
MFR (230° C.; 2.16 Kg)=7-12 in the ratio of 4:1 w/w compounded
Primer 4=PE-(MD)-(MAH) with MFR (190° C.; 21.6 Kg)=12-22 and Infuse
9808.15 in the ratio of 2:1 w/w compounded (DOW Chemical Company)
Test fuel composition:

| | FAM B vol.-% |
|---|---|
| Methanol | 15.00 |
| Water | 0.50 |
| Toluene | 42.25 |
| Isooctane | 25.35 |
| Dilsobutylene | 12.68 |
| Ethanol | 4.23 |
| Total | 100.00 |

IR: Infrared welding; VIB: Vibration welding;

Production of the test specimens:

In order to produce the primer polymers, PE-(MD)-MAH and PP-MAH polymer granulate was premixed in different ratios, melted in the plasticizing unit of an injection molding machine (230° C.) and compounded and processed to form plates of 130 mm×70 mm×3 mm. The composition of the primers can be found in the following table in Kg.

| Primer | | | |
|---|---|---|---|
| no. | PE-(MD)-MAH | PP-MAH | Ratio PE-MAH:PP-MAH w/w |
| 1 | 5 | 5 | 1:1 |
| 2 | 10 | 5 | 2:1 |
| 3 | 8 | 2 | 4:1 |

The plates were milled down to 130 mm×68 mm×3 mm and the 130 mm×3 mm surface was welded, until impact and by means of IR and vibration welding, to PE and PP in each case having the same surface area. 24 hours after welding, 8 mm was milled off from both ends of the plate, the rest of the plate was halved (cut perpendicular to the joining plane) and was tested by means of a tensile test at room temperature and at a testing speed of 50 mm/s. The following table gives the results for each combination of primer, plastics material and welding method used, together with the tensile strength (in MPa) which was achieved for the welded test specimens:

| | | | | Tensile |
|---|---|---|---|---|
| | | | Welding | strength |
| Polymer 1 | Polymer 2 | Primer no. | method | MPa |
| PE Lupolen GX5038BG25 | PP Sabic | — | VIB | 11.12 |
| | 4935 | | | |
| PE Lupolen GX5038BG25 | PP Sabic | — | IR | 10.30 |
| | 4935 | | | |
| PE Lupolen GX5038BG25 | — | 2 | VIB | 17.28 |
| PE Lupolen GX5038BG25 | — | 2 | IR | 18.81 |
| PP Sabic 4935 | — | 2 | VIB | 18.05 |
| PP Sabic 4935 | — | 2 | IR | 20.59 |
| PE Lupolen GX5038BG25 | — | 3 | VIB | 16.60 |
| PP Sabic 4935 | — | 3 | VIB | 14.94 |

The results show that the samples welded using Primer no. 2 exhibit outstanding tensile strength. In this case the (Primer no. 2) PE and (Primer no. 2) PP composite approximately achieves the basic PE strength of 19.13 MPa. Thus, using the primer, particularly rigid welding of the plastics materials PE and PP can be achieved.

The plates that were IR welded in the same way were stored for 14 days at 25° C. in the test fuel FAM-B in order to test the media resistance of the welded connection. The tensile strengths of the welded and milled plates at room temperature at a testing speed of 50 mm/s are shown in the following table.

| | | | | Tensile |
|---|---|---|---|---|
| | | | | strength |
| Polymer 1 | Polymer 2 | Primer no. | Aging | MPa |
| PE Lupolen | PP Sabic | — | 14 days at 25° C. in | 0.51 |
| GX50386G25 | 4935 | | FAM-B | |
| PE Lupolen | — | 2 | 14 days at 25° C. in | 12.86 |
| GX5038BG25 | | | FAM-B | |
| PP Sabic | — | 2 | 14 days at 25° C. in | 11.51 |
| 4935 | | | FAM-B | |

The results show outstanding aging resistance of the welded samples with respect to the test fuel FAM-B.

In order to test the PE/primer-polymer/PP composite having a separate primer layer, plates of 130 mm×3 mm of Primer 2 were IR welded to PP Sabic 4935. The primer plates were then milled down such that 0.5 mm of the primer layer remained on the PP plate, and the primer layer was welded to PE Lupolen GX5038BG25 plates also of 130 mm×3 mm. A structure of PE/(Primer 2)/PP was thus achieved.

After 24 hours, the IR welded polymers were tested in the tensile test as described above at room temperature at 50 mm/s.

The samples exhibited outstanding tensile strength of 15.14 MPa. Outstanding strength of Primer 2 could thus be obtained when welding PE and PP.

Reaction of PE-MAH and PP-MAH with Hexamethylenediamine:

PE-MAH and PP-MAH were reacted in a solution with hexamethylenediamine. The amounts of reactant and solvent used are listed in the following table.

| Primer no. | PE-MAH | PP-MAH | Hexamethylenediamine | Xylene |
|---|---|---|---|---|
| 5 | 17.5 g | 17.5 g | 1.0 g | 315 ml |
| 6 | 10.0 g | 10.0 g | 0.5 g | 180 ml |
| 7 | 10.0 g | 10.0 g | 0.8 g | 180 ml |

PE-MAH and PP-MAH were dissolved in xylene at 130° C. in a 500-ml two-necked flask, and the amine, dissolved in 20 ml xylene, was then slowly introduced, drop-by-drop, by means of a dropping funnel. After 2.5 hours under reflux, the reaction mixture was poured into 500 ml water, filtered by means of a Büchner funnel and washed a number of times with small amounts of acetone. Colorless solids were obtained after drying in a vacuum.

The primer polymers obtained were melted down on PE Lupolen GX5038BG25 and on PP Sabic 4935 by means of warm gas, and the adherence was tested for quality after cooling. Primers 5, 6 and 7 exhibited outstanding adherence with respect to PE and to PP.

What is claimed is:

1. A method for welding two different polyolefin plastics materials using a primer, wherein the primer contains at least one maleic acid anhydride-grafted polyolefin polymer.

2. The welding method according to claim 1, characterized in that the polyolefin plastics materials polyolefinic polymers can be selected from the group consisting of poly-alpha-olefin homopolymers based on ethene, propene and/or butene, in particular ethene homopolymers or propene homopolymers, and poly-alpha-olefin copolymers based on ethene, propene, 1-butene, 1-hexene and 1-octene, in particular ethylene/alpha-olefin and propylene/alpha-olefin copolymers, preferably copolymers of ethylene or propylene having 1-butene, 1-hexene, 1-octene or a combination thereof.

3. The welding method according to claim 1, characterized in that the first joining part is a polyethylene-plastics material, in particular a HD polyethylene, MD polyethylene, LD polyethylene, UHMW polyethylene or LLD polyethylene plastics material, and the second joining part is a polypropylene plastics material.

4. The welding method according to claim 1, characterized in that the at least one maleic acid anhydride-grafted polyolefin polymer is selected from maleic acid anhydride-grafted polyethylenes or maleic acid anhydride-grafted polypropylenes.

5. The welding method according to claim 1, characterized in that the primer contains a mixture of maleic acid anhydride-grafted polyolefins, in particular a mixture of at least one maleic acid anhydride-grafted polyethylene and at least one maleic acid anhydride-grafted polypropylene.

6. The welding method according to claim 5, characterized in that the at least the ratio of the different maleic acid anhydride-grafted polyolefin polymers, in particular the ratio of maleic acid anhydride-grafted polyethylene to maleic acid anhydride-grafted polypropylene is 0.2:1 to 20:1, in particular 0.5:1 to 10:1, preferably 1:1 to 5:1, particularly preferably 1.5:1 to 3:1.

7. The welding method according to claim 1, characterized in that the at least one maleic acid anhydride-grafted polyolefin or the mixture thereof has a maleic acid anhydride content of from 0.01-15 wt. %, in particular 0.02-10 wt. %, preferably 0.05-8 wt. %, particularly preferably 0.5-5 wt. %, based on the polyolefin polymer or the mixtures thereof.

8. The welding method according to claim 1, characterized in that at least some of the maleic acid anhydride groups of the polyolefin polymer are reacted with amines, in particular aliphatic amines, preferably aliphatic diamines, such as hexamethylenediamine; preferably 5-100 mol %, in particular 10-80 mol %, preferably 20-70 mol % of the maleic acid anhydride groups of the polymer according to the invention or the mixture thereof.

9. The welding method according to claim 1, characterized in that the primer contains, in addition to the maleic acid anhydride-grafted polyolefin polymer, at least one further polymer that is compatible with at least one of the two plastics materials to be welded.

10. An item produced in accordance with a welding method according to claim 1.
